(19) United States
(12) Patent Application Publication
(10) Pub. No.: US 2004/0098871 A1
(43) Pub. Date: May 27, 2004

(54) Sundial

(76) Inventor: Barry Stanton Waltho, Altrincham (GB)

Correspondence Address: CONLEY ROSE, P.C., P. O. BOX 3267, HOUSTON, TX, 77253-3267, US

(21) Appl. No.: 10/221,808

(22) PCT Filed: Mar. 16, 2001
(86) PCT No.: PCT/GB01/01148

(30) Foreign Application Priority Data
Mar. 16, 2000 (GB) 0006338.8

(51) Int. Cl. G01C 17/34

(52) U.S. Cl. 33/270

(57) ABSTRACT

A vertical sundial comprises a substantially flat dial face (2) provided with dial markings and gnomon (3) supported in a fixed position relative to the dial face (2) which in use casts a shadow on a first side of the dial face (2). The sundial is adapted to be free-standing on a generally flat and horizontal surface and the dial face (2) is translucent such that the shadow cast by a gnomon on the first side of the dial face can be observed from the second side of the dial face. The dial markings are adapted to be read from the second side of the dial face to give a time indication.

Sundials are well known instruments for indicating the time of day by reference to the position of the sun by virtue of a shadow cast by a gnomon on an appropriately marked surface (the face of the sundial). Sundials most commonly found today are horizontal sundials (i.e. having horizontal dial faces) intended for ornamental purposes. Sundials can however have a face inclined to the horizontal and indeed sundials with vertical (or near vertical) faces mounted to the walls of public buildings were at one time very common. For convenience such sundials will be referred to hereinafter as “vertical” sundials.

If a sundial is to give accurate readings then the markings on the dial face must take account of the latitude at which the dial is to be situated. For vertical dials the orientation (declination) of the face of the sundial (i.e. the deviation of the plane of the dial face from the east-west direction) must also be taken into account. For instance a vertical sundial which is designed to face directly south (so that its face lies in a plane running exactly east-west), referred to as a “vertical direct south dial”, will not give accurate readings if mounted with a different declination. The factors which must be taken into account when marking a sundial are well known to those skilled in the art.

Whilst marking a vertical direct south sundial is a relatively straight forward procedure, marking vertical declining dials is considerably more complicated. This is a significant disadvantage of vertical sundials as compared with horizontal sundials which need only take account of the latitude which the dial is to be positioned.

A further disadvantage of conventional vertical sundials is that they can only be viewed from outside the building etc to which the sundial is mounted.

It is an object of the present invention to obviate or mitigate the above disadvantages.

According to a first aspect of the present invention there is provided a vertical sundial comprising a substantially flat dial face provided with dial markings, a gnomon supported in a fixed position relative to the dial face which in use casts a shadow on a first side of the dial face, wherein the sundial is adapted to be free-standing, on a generally flat and horizontal surface and said dial face is translucent such that the shadow case by the gnomon on said first side of the dial face can be observed from the second side of the dial face, said dial markings being adapted to be read from said second side of the dial face to give a time indication.

A sundial in accordance with the present invention can therefore be placed on a windowsill or the like with its first surface facing towards the sun (i.e. towards the outside) and yet be observed from within the room etc in which the window is located. As such, the sundial may provide an attractive and instructional ornament.

It is to be understood that the reference to a “vertical” sundial is to a sundial in which the dial face is inclined to the horizontal. The dial face need not necessarily be precisely vertical and may lean forwards or backwards.

It is also to be understood that the dial face must be translucent in the sense that it must facilitate the projection of a shadow on its first side which is visible from its second side. For instance, if the dial face is highly transparent it may not be possible to discern the shadow cast by the gnomon. Similarly, if the dial face is opaque the shadow cast by the gnomon will not be visible from the second side of the dial face. The term “translucent” as used hereinafter is to be interpreted accordingly.

The dial face and gnomon may be fixed to one another such that they are adapted to be self supporting on an appropriate surface. In preferred embodiments, however, the dial face and gnomon are mounted to a common base in fixed positions relative to one another.

Preferably the sundial further comprises a locating member which in use provides at least two abutment points defining an orientation reference line, said locating member being adapted to allow the orientation of the reference line relative to the dial face and gnomon to be set to at least one of a range of alternative orientations.

In a preferred embodiment the range of orientations is continuous, i.e. the Orientation is completely adjustable either between limits (eg over a 180° range) or over 360°.

In a preferred embodiment the locating member being pivotable relative to the dial face and gnomon in an angular direction substantially perpendicular to said dial face, locking means being provided to selectively lock the locating member, and thus the orientation reference line, in a set angular position relative to the dial face.

The locating member is provided to enable the declination of the dial face to be adjusted and preferably locked in a set position relative to an external fixed reference. That is, for a given orientation of the locating member and orientation reference line, the angular orientation of the dial face relative to the orientation reference line can be adjusted by reference to the direction of a shadow cast by the gnomon at a known time to set the correct orientation of the dial face. For instance, if the sundial is placed on a windowsill it may be pushed up against a reference surface (such as a window frame) so that the orientation reference line lies parallel to the reference surface, whereafter the dial face and gnomon can be pivoted relative to the locating member and locked in a selected position (determined by reference to the shadow cast by the gnomon at a known time of day) to set the orientation of the dial relative to that particular reference surface. Thereafter the sundial can be removed and returned to its original position simply by aligning the orientation reference line along the reference surface without any need to reset the orientation of the dial face.

Preferably the orientation reference line is defined by an elongate straight edge of the locating member.

The locating member may be pivotably mounted to a base which supports the dial face and/or gnomon, or alternatively directly to the gnomon or dial face (particularly where no base is provided and the dial face/gnomon are self supporting).

The locating member locking means may comprise a simple nut and bolt arrangement which may be loosened to allow adjustment of the relative angular positions of the locating member and the dial face/gnomon and then tightened to lock the angular positions relative to one another once the orientation has been set.

A sundial according to the present invention may preferably be provided with means by which the inclination of the dial face and gnomon relative to the sun may be adjusted. Suitable means by which this may be achieved may include a pivot around which a base bearing the dial face and gnomon may rotate.

It may be preferred that a sundial in which the inclination of the dial face and gnomon relative to the sun may be adjusted be provided with props by which the inclination of the dial face and gnomon may be maintained at a desired degree of inclination.

The dial face and/or gnomon are supported on a base which is rotatably mounted on a supporting plinth said plinth defining said orientation reference line and thus constituting said locating member.

The sundial may be provided as a kit of parts for home assembly. In this regard, interchangeable pre-marked dials may be provided to be selected by the user as appropriate. For instance, the dials could have different markings for different latitude ranges, or different decorational features. In this regard, the dial face may for instance comprise a dial marked on a thin flexible medium (such as paper/cellulose or the like) sandwiched between two rigid support plates made of glass or the like so that the dial face can be readily changed simply by substituting one marked dial for another.

Benefits of provision of an angle locator are not limited to vertical sundials and can, for instance, be applied to horizontal sundials. Thus, according to a second aspect of the present invention there is provided a sundial comprising a substantially horizontal dial face provided with dial markings, a gnomon supported in a fixed position relative to the dial face, and a locating member which in use provides at least two abutment points defining an orientation reference line, said locating member being adapted to allow the orientation of the reference line relative to the dial face and gnomon to be set to at least one of a range of alternative orientations.

Other alternative and preferred features of the sundial will become apparent from the following description.

A specific embodiment of the present invention will now be described, by way of example only, with reference to the accompanying drawings, in which:

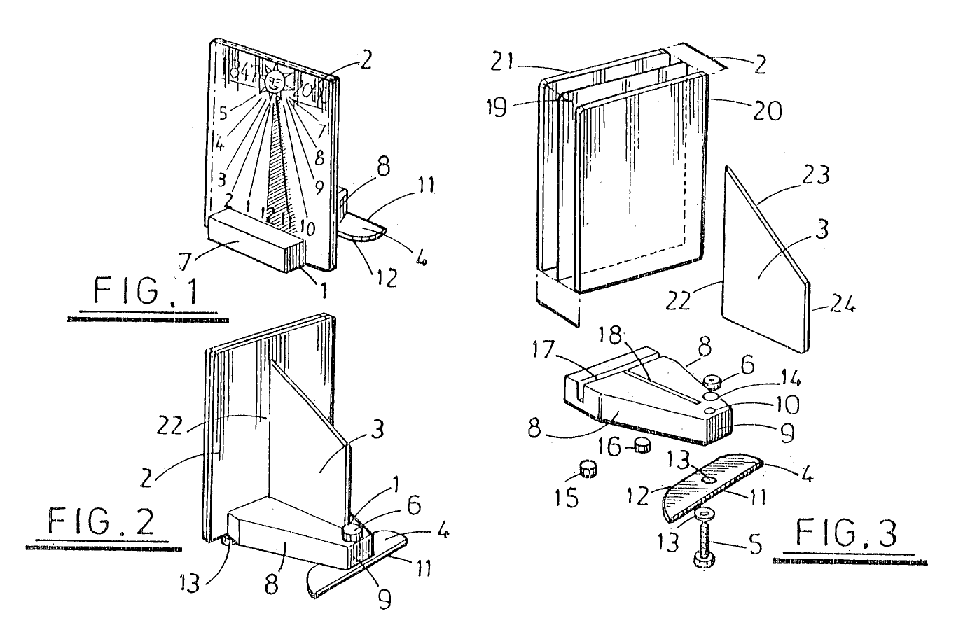

FIG. 1 is a front perspective view of a sundial in accordance with a first embodiment of the present invention;

FIG. 2 is a rear perspective view of the sundial of FIG. 1;

FIG. 3 is an exploded view illustrating the individual components of the sundial of FIGS. 1 and 2;

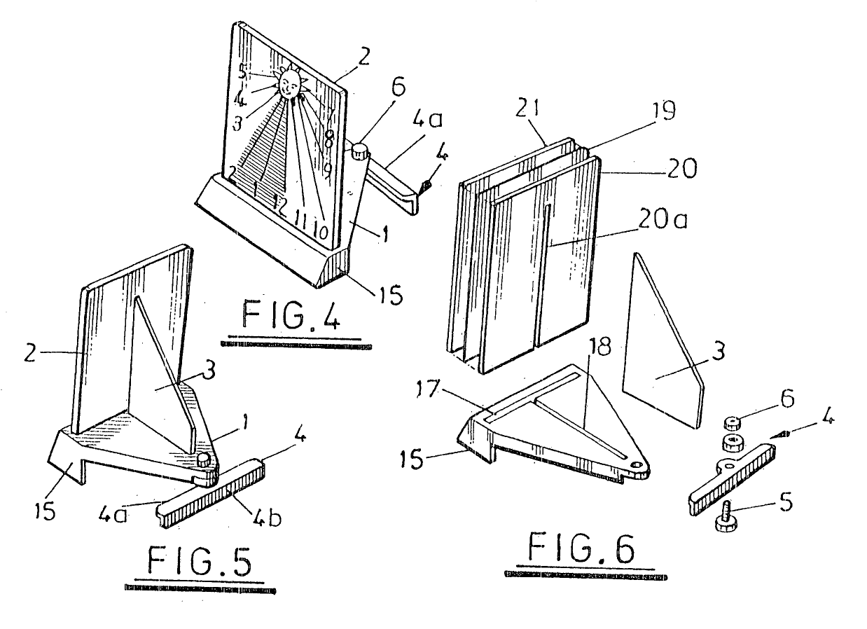

FIG. 4 is a front perspective view of a sundial in accordance with a second embodiment of the present invention;

FIG. 5 is a rear perspective view of the sundial of FIG. 4;

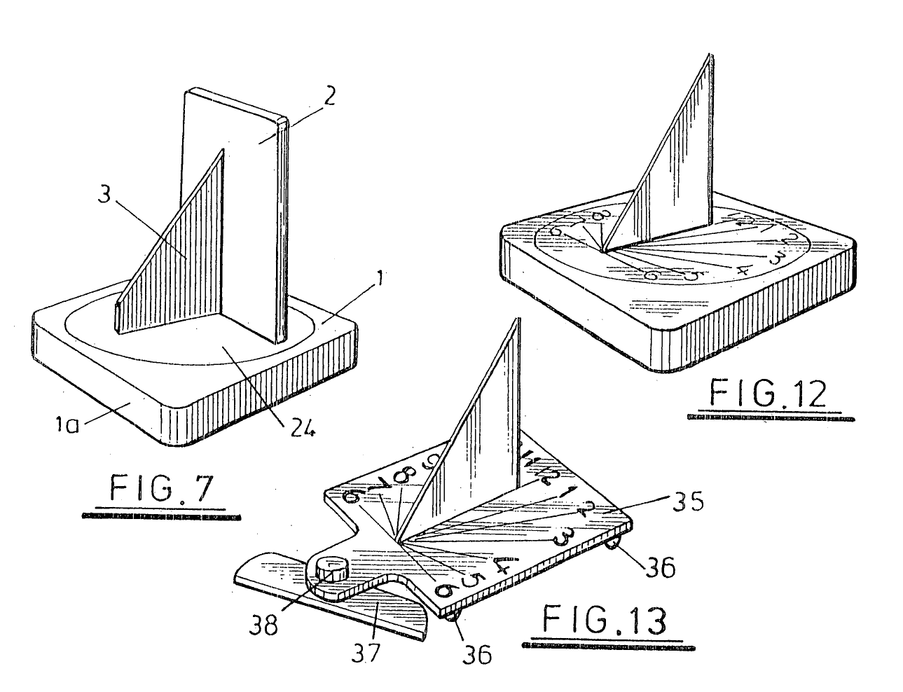

FIG. 6 is an exploded view illustrating the individual components of the sundial of FIGS. 4 and 5;

FIG. 7 is a rear perspective view of a sundial in accordance with a third embodiment of the present invention;

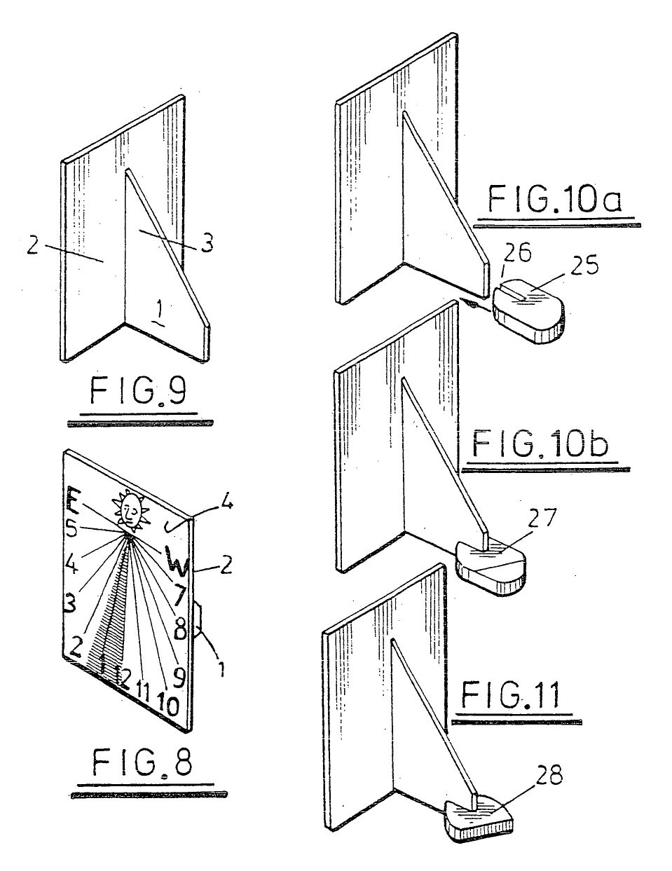

FIGS. 8 to 11 are various illustrations of a sundial in accordance with a fourth embodiment of the present invention;

FIG. 12 is a perspective illustration of a sundial in accordance with the fifth embodiment of the present invention;

FIG. 13 is a perspective view of a sundial in accordance with a sixth embodiment of the present invention;

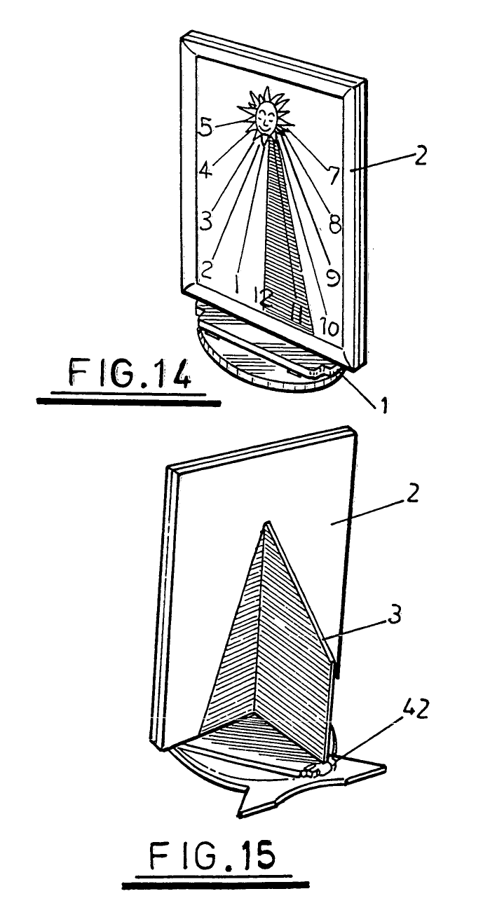

FIG. 14 is a front perspective view of a sundial in accordance with a seventh aspect of the present invention;

FIG. 15 is a rear perspective view of the sundial of FIG. 14;

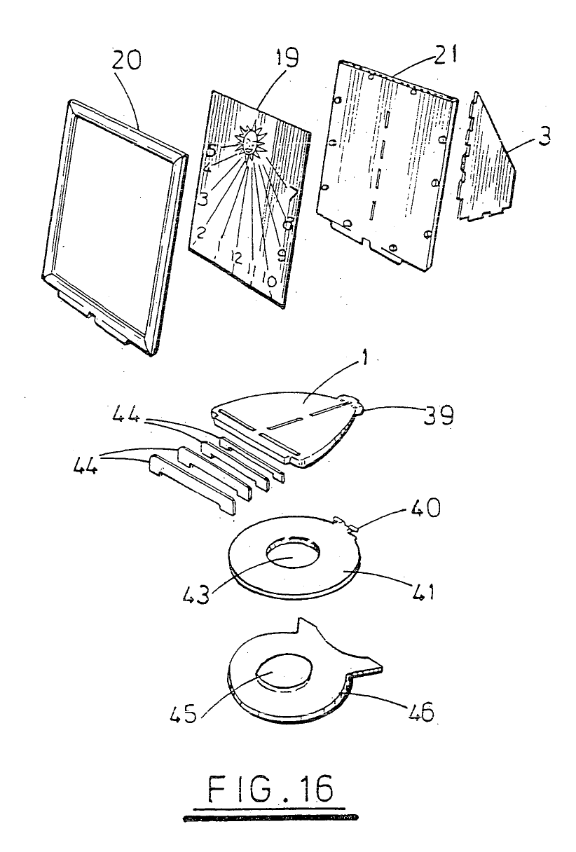

FIG. 16 is an exploded view illustrating the individual components of the sundial of FIGS. 14 and 15; and

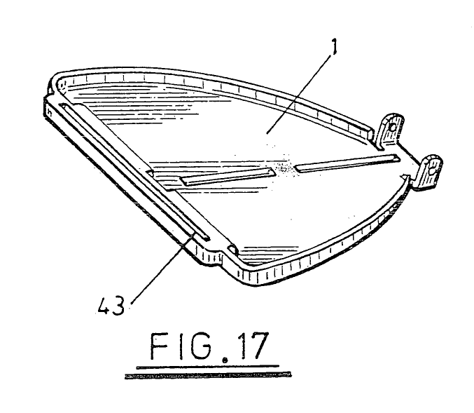

FIG. 17 illustrates the base of the sundial of FIGS. 14 to 16 inverted.

The illustrated sundial comprises a base 1 which supports a rectangular dial face 2, a gnomon 3 and an angle locator 4 which is secured to the underside of the base 1 by a bolt 5 and knurled nut 6.

The base 1 is flat and generally triangular in plan having a front edge 7 and two side edges 8 that converge towards a squared off apex 9. A hole 10 is provided through the base 1 in the region of its apex 9 to receive the bolt 5.

The angle locator 4 is a thin plate shaped like the segment of a circle having a straight edge 11 and an arcuate edge 12. A hole 13 is provided in the centre of the angle locator 4 to receive the bolt 5 by way of which the angle locator 4 is secured to the underside of the base 1. The angle locator may be pivoted on the bolt 5 unless locked in position by tightening the knurled nut 6. With the angle locator positioned so that its straight edge 11 is aligned parallel with the front edge of the base 1, the straight edge 11 defines the rear most edge of the sundial.

The bolt 5 passes upwards through the bottom of the angle adjuster 4 and the base 1, washers 13 and 14 being provided between the bolt head and angle adjuster 4, and the knurled nut 6 and upper surface of the base plate 1. The head of the bolt 5 provides a rear foot which together with two front feet 15 and 16 provided adjacent the front edge 7 of the base support the base 1 horizontally on a suitably flat horizontal surface (not shown).

The upper surface of the base 1 is provided with two straight slots 17 and 18 arranged in a T shape with slot 17 extending adjacent and parallel to the front edge 7 of the base 1 and slot 18 extending centrally towards the hole 10 at the apex 9 of the base 1. The slots 17 and 18 are provided to support the dial face 2 and gnomon 3 respectively as described below.

The dial face 2 is rectangular and plate shaped comprising three laminated elements, namely a translucent paper dial 19 (bearing appropriate hour markings and any other desirable information or decoration) sandwiched between two transparent or translucent sheets of glass or plastic 20 and 21. The laminated face 2 is supported upright in the groove 17 of the base 1 (which not only supports the face but holds the three elements 20-21 together) with the dial markings facing the front edge 7 of the base thereby defining the front of the sundial.

The gnomon 3 is a flat “fin” which fits in the slot 18 and is thereby supported vertically by the base 1. The gnomon has a vertical front edge 22 which abuts against the rear surface of the face 2 (i.e. glass plate 20) along a line corresponding with the vertical 12 o'clock marking on the dial 19. The upper edge 23 of the gnomon (referred to as the “style”) 3 is appropriately inclined at an angle to the horizontal and drops away towards a rear vertical edge 24.

From the above description it will appreciated that the described embodiment of the invention comprises relatively simple components which are cheap and easy to manufacture and assemble.

In accordance with one aspect of the present invention the illustrated sundial is designed to be viewed from the opposite side of the face to that on which the sunlight falls. That is the gnomon 3 casts a shadow on the back of the dial face 2 which is visible from the front of the face 2 by virtue of its translucency. The sundial can therefore, for instance, be set on the windowsill of a generally south facing window of a room and be read by occupants of the room which is not so easily possible with conventional sundials.

As mentioned above, the markings of a vertical sundial must take account of both the latitude and the orientation of the dial location. Providing “custom” marked dials for particular precise latitude positions is not convenient practically but in practice a certain amount of tolerance can be accepted given that the sundial is not intended as a precise scientific instrument. The sundial could for instance be provided with a small number of alternative dials 19 (bearing in mind that the dial 19 is a printed piece of translucent paper) for use in different regions there being a certain amount of compromise in the accuracy in the readings. For example, the difference in latitude between the north and south of the British Isles is 7½⁰ and it may be considered sufficient to provide four alternative dial sheets 19 (and suitably angled gnomons) each covering a different latitude range to provide acceptable results covering the most populated areas of the British Isles with a latitudinal error no greater than approximately 1°.

With regard to difficulties associated with the orientation, declination, of the sundial, these are solved by the present invention by the provision of the angle locator 4. Operation of the angle locator 4 (which is described in detail below) provides means for adjusting the orientation of the dial face to match the assumed declination on which the dial markings are based (which will normally be based on a vertical direct south declination).

In use the sundial may be placed on the windowsill of a generally south facing window with the front of the face 2 facing away from the sun (i.e. facing generally north and into the room etc in which the window is provided). The straight edge 11 of the angle adjuster 4 is then pushed up against a suitably straight reference surface, such as the bottom rail of the window frame (not illustrated). The knurled nut 6 is then loosened so that the base 1 can be pivoted relative to the angle locator 4 which is effectively held in a fixed position by virtue of its abutment with the window frame. This allows the orienatation of the face 2 to be set by reference to the shadow cast by the gnomon 3 assuming the solar time is known. This operation is most conveniently performed at solar noon (the details of which can be provided with the sundial) in which case the base is pivoted until the shadow cast by the gnomon 3 on the back of the face 2, as observed from the front of the face 2, lies on the 12 o'clock hour marking. The knurled nut 6 is then tightened to lock the relative angular positions of the angle locator 4 and base 1. The sundial will then give accurate solar time readings provided it is simply ensured that the straight edge 11 of the angle locator 4 is pushed up against the window frame etc used as the reference when the declination was set.

Not only does the angle adjuster 4 provide a simple way of setting the orientation of the face 2 to correspond with the assumed declination of the markings on the dial 19, it also obviates the need to reset the orientation each time the sundial is temporarily moved (e.g. to clean the windowsill etc) since the declination will remain correct provided the sundial is repositioned with the angle locator 4 pressed against the reference window frame etc.

It will be appreciated that all instructional information required for setting up and operation of the sundial can be supplied with the sundial. No attempt will be made here to discuss the various factors which affect, for instance, the determination of solar noon and other aspects of the operation of a sundial (all of which will be well known to those skilled in the art and easily explained- to those who are not).

The sundial in accordance with the present invention can be conveniently set up for use in an window through which the sun shines and no consideration need be given to the facing direction of the window when providing the markings on the dial 19. The sundial can be moved from one window to another and reset by appropriate adjustment of the angle locator.

It will be appreciated that whereas the dial 19 will most likely be marked as a direct south facing sundial (since these markings are more easily calculated than those for a different orientation) there is no reason why the dial cannot be marked on the assumption of a different declination although this will have no practical purpose and will simply introduce complications in the design of the sundial.

It will also be appreciated that many modifications can be made to the detailed design of the sundial illustrated. For instance, the angle locator 4 need not be shaped as a segment of a circle, and indeed need not have a straight edge 11. For instance, the angle locator could be a V shaped member pivoted at its apex, positioning being achieved by pressing the ends of the V shaped arms against an appropriate reference surface.

Similarly, the base need not have the shape or design of that illustrated and alternative means may be provided for supporting the face 2 and gnomon 3. The shape and design of the face 2 may also vary considerably. The essential feature of the face 2 is that it is translucent so that a shadow cast on its rear surface is visible from its front surface. The laminar arrangement described is advantageous in that it enables a common design to accommodate a wide range of cheaply produced dials printed on translucent paper or the like (the dial could be printed on transparent paper provided one or other of the plates 20/21 is translucent rather than transparent so that the shadow cast by the gnomon can be observed). Alternatively the dial could be printed on a suitable transparent or translucent adhesive sheet and only a single support plate 20 or 21 provided, or the dial could be printed directly on to the support plate.

A modification of the sundial of FIGS. 1 to 3 is illustrated in FIGS. 4 to 6. Like reference numerals will be used for corresponding components. With this embodiment the base 1 is a moulded component provided with two integral front feet 15 and 16 (anyone of which is visible in the drawings. The angle locator 4 has the form of a right angle sectioned beam comprising a horizontal surface which is secured to the base one in essentially the same mariner as te angle locator 4 of the sundial of FIGS. 1 to 3 is secured to its base) and a vertical depending face 4b which provides both the reference edge of the angle locator and also a rear “foot” to support the base 1 horizontally.

Other differences between the embodiment of FIGS. 4 to 6 and that of FIGS. 1 to 3 are that the slots 17 aid 18 have closed rather than open ends which provide more accurate location for the dial face 2 and gnomon 3 respectively and also that the rear plate 20 of the dial face is provided with a vertical 20a to provide a positive location for the gnomon 3.

It will be appreciated that use of the sundial FIGS. 4 to 6, and in particular the setting of the orientation of the dial by use of the angle locator 4 is the same as that of the embodiment of FIGS. 1 to 3.

In the above described examples of the invention the base 1 directly supports the face 2 and gnomon 3 on a surface (such as a windowsill). In an alternative embodiment the face 2 and gnomon 3 could be mounted on a base which is pivotably mounted on a supporting plinth provided with a reference edge (or similar formation) for alignment with the window etc so that the angle adjustment is provided by rotation of the face/gnomon relative to the base. An example of such an alternative embodiment is illustrated in FIG. 7. With this embodiment the dial face 2 and gnomon 3 are mounted on a circular base 24 which is rotatable within a square plinth 1. In this instance the reference edge is provided by rear side 1a of the plinth 1 rather than by an adjustable angle locator. Rather, adjustment of the orientation is made by pushing the side 1a of the base 1 against a suitable reference surface (such as a window frame) and then rotating the base 24 to adjust the orientation of the face 2 (the gnomon 3 rotating with the face 2 and thus remaining in a fixed orientation with respect thereto). The modified base 24, and the plinth 1, could for instance be moulded plastic components, the base 24 being a snap fit within the plinth 1.

As a further alternative the face and gnomon could be secured together, or otherwise adapted, so that they are self supporting, not requiring a base mounting. In this case the angle locator could, for instance, be pivotally mounted directly to the gnomon or dial face.

An example of an embodiment of the present invention in which the face and gnomon are secured together and self supporting, and incorporating an alternative for of angle locator from that described in relation to the embodiments above, is illustrated in FIGS. 8 to 11. This embodiment comprises a gnomon 3 fixed to a dial face 2 and an angle locator 25. In this instance the angle locator is in the form of a pad of material, such as rubber, which can readily be cut. The pad 25 is flat and generally oval and provided with a slot 26 cut into one end by virtue of which the pad can be slotted on to the gnomon 3 as indicated by FIGS. 10a and 10b. To set the orientation of the sundial the rear curved end of the pad 25 is pushed up against a window sill and the sundial turned to the correct declination in the manner described above. A reference line indicated at 27 in FIG. 10b, is then drawn on the pad 25 parallel to the external reference surface (i.e. window frame or the like) against which the sundial has been placed. This can for instance, readily be achieved by providing a thin strip of card which can be pushed against the reference surface lying on top of the pad 25. Once the reference line 27 has been drawn the pattern 25 is then cut along this line to provide a straight orientation reference edge which can then be pushed up against the external reference surface to maintain the correct orientation. The size of the pad 25, and also width of the strip etc used to mark the reference line 27, can be such that several cuts can be made successively to “re-set” the orientation reference line.

Each of the examples of the present invention so far described is a vertical sundial. However, as mentioned above one aspect of the present invention. i.e. provision of means to set the declination or orientation of a sundial, also has application to horizontal sundials which may be designed for indoor use. Examples of such horizontal sundials are illustrated in FIGS. 12 and 13. FIG. 12 is a horizontal sundial based on the design of the vertical sundial FIG. 7 in that it comprises a rotatable base 30 mounted in a square plinth 31. However, in this instance the rotatable base 30 is marked as a horizontal sundial face and supports a vertically upstanding gnomon 33. Here again any side of the square plinth 31 can provide a reference edge which can be pushed up against a fixed reference surface allowing the orientation of the sundial face to be subsequently set. As with the vertical sundial of FIG. 7, the square plinth can be replaced with any other shape plinth provided it defines either a reference edge or reference abutments which can be pushed up against a fixed external reference surface.

FIG. 13 is an example of a horizontal sundial incorporating a rotatable angle locator of the same general form of that illustrated in relation to the embodiments of FIGS. 1 to 3 and 4 to 6. The horizontal sundial of FIG. 13 comprises a horizontal dial face 35 supported on the 36 (one of which is placed at each corner of the rectangular dial 35). The dial face 35 has a portion protruding from one end thereof to which is pivotally secured a flat angle locator 37 (by means of bolt 38 or the like). The dial face 35 supports vertically standing gnomon 38. Operation of the angle locator 37 is essentially the same as that of the angle locator 4 of the embodiment of FIGS. 1 to 3 and FIGS. 4 to 6.

It will be appreciated that horizontal sundial embodiments of the present invention could be adapted to include an eagle locator of the same general form as that illustrated in relation in the embodiment of FIGS. 8 to 11. It will also be appreciated that with the horizontal sundial there is no requirement for the dial face to be translucent or transparent.

FIGS. 14 to 17 illustrate an alternative embodiment of a rotatable vertical sundial which incorporates means to adjust the vertical inclination of the dial face 2 and gnomon 3.

A dial face 2, constructed of a dial 19 sandwiched between sheets 20 and 21 which are adapted to snap together, and a gnomon 3 are attached to a base 1. The posterior part of base 1 is adapted to form female hinge members 39 which co-operate with male hinge members 40, located on a ring 41, to form a hinge 42.

Base 1 is adapted, through the provision of a slot 43 on its underside, to receive props 44, hereinafter called latitude plates. Slot 43 may be more clearly seen in FIG. 17. When in use the latitude plates prevent pivoting the base 1 about the hinge 42 towards the ring 41, thereby maintaining the angle of the base 1 and ring 41 relative to each other.

An aperture 43 within ring 41 receives a nub 45 which extends from a stand 46. Ring 43 and stand 46 are thereby able to rotate relative to one another.

An advantage of the embodiment of the invention illustrated in FIGS. 14 to 17 over the previously described embodiments is that the inclination of dial face 2 and gnomon 3 to the sun may be altered. Such alterations in the inclination allow the sundial to be adjusted to compensate for the latitude at which it is located without changing the gnomon. In the example illustrated the adjustment of inclination is achieved by pivoting the base 1 about hinge 42. A range of sizes of latitude plates may be provided to enable the angle of inclination of the dial face 2 and gnomon 3 to be increased in desired increments. Such increments may correspond to a known change of latitude. A suitable range of latitude plate sizes may be those necessary to encompass a range of latitudes covering the area in which the sundial is to be marketed.

Other possible modifications will be readily apparent to the appropriately skilled person.

1. A vertical sundial comprising a substantially flat dial face provided with dial markings, a gnomon supported in a fixed position relative to the dial face which in use casts a shadow on a first side of the dial face, wherein the sundial is adapted to be free-standing on a generally flat and horizontal surface and said dial face is translucent such that the shadow case by a gnomon on said first side of the dial face can be observed from the second side of the dial face, said dial markings being adapted to be read from said second side of the dial face to give a time indication.

2. A sundial according to claim 1, further comprising a locating member which in use provides at least two abutment points defining an orientation reference line, sad locating member being adapted to allow the orientation of the reference line relative to the dial face and gnomon to be set to at least one of a range of alternative orientations.

3. A sundial according, to claim 2, wherein said range of orientations is continuous.

4. A sundial according to claim 2 or claim 3), wherein the orientation of said locating member orientation reference line may be reset two or more times to different orientations.

5. A sundial according to any preceding claim, wherein the locating member is pivotable relative to the dial face and gnomon.

6. A sundial according to any preceding claim, wherein locking means are provided to selectively lock the locating member and thus the orientation reference line, in a set angular position relative to the dial face.

7. A sundial according to claim 5 or claim 6 wherein said locating member is pivotable in a plane which is substantially horizontal when the sundial is in use.

8. A sundial according to anyone of claims 5 to 7, wherein the orientation reference line extends at the rear of the sundial such that in use the sundial may be pushed up against a reference surface extending from a horizontal surface on which the sundial is placed such that said at least two points abut said surface so that the orientation reference line lies parallel to said surface, whereafter the dial face and gnomon can be pivoted relative to the locating member and locked in a selected position to set the orientation of the dial face relative to the reference surface.

9. A sundial according to any one of claims 5 to 8, wherein said at least two points lie on a straight edge or face defined by the locating member.

10. A sundial according to any one of claims 5 to 9, wherein said locating member is pivotably mounted to said gnomon, said dial face, or a base which supports the dial face and/or gnomon.

11. A sundial according to claim 10, wherein the gnomon and dial face are supported by a common base for supporting said dial face and gnomon on a generally horizontal surface and maintaining them in a fixed position relative to one another, wherein the locating member is pivotably attached to said base.

12. A sundial according to claim 11, wherein said locating member is a substantially flat member pivotably mounted to an underside of said base.

13. A sundial according to claim 11 or claim 12, wherein said locking means comprises a nut and bolt or the like-which may be loosened to allow adjustment of the relative angular positions of the locating member and the base and tightened to lock the locating member and base in a selected angular position relative to one another.

14. A sundial according to claim 10, wherein the dial face and/or gnomon are supported on a base which is rotatable mounted on a supporting plinth, said plinth defining said orientation reference line and thus constituting said locating member.

15. A sundial according to claim 14, wherein said base is circular and is rotatably mounted within a circular recess provided by said plinth.

16. A sundial according to claim 14 or claim 15, wherein said plinth has at least one straight edge defining said orientation reference line.

17. A sundial according to any one of claims 11 to 16, wherein the dial face has a lower edge which is received in a slot provided in an upper surface of the base to support the dial face in position but allowing the dial face to be easily removed and replaced.

18. A sundial according to any one of claims 11 to 17, wherein said gnomon is shaped like a flat fin and is mounted in a second slot provided in the base and supported in a fixed position relative to the dial face but such that it may be readily removed and replaced.

19. A sundial according to any preceding claim, wherein the dial face comprises a dial marked on a thin flexible medium such as paper or the like, sandwiched between two rigid support plates made of glass or the like, said dial and support plates being translucent or transparent provided at least one of the dial or support plates is translucent.

20. A sundial according to any preceding claim, wherein the dial face comprises a dial marked on a thin flexible adhesive medium which is supported on a support plate, said dial and support plate being translucent or transparent to provide at least one of the dial or support plinths is translucent.

21. A sundial according to any preceding claim, further comprising means by which the vertical inclination of the dial face and gnomon relative to the sun may be adjusted.

22. A sundial according to claim 21, wherein the means comprise a hinge around which a base bearing the dial face and gnomon may pivot in a vertical plane.

23. A sundial according to claim 21 or claim 22, further comprising means for maintaining the dial face at a predetermined inclination.

24. A sundial according to claim 23, wherein said means comprise one or more props by which the dial face and gnomon may be supported at a desired degree of inclination.

25. A sundial according to claim 24, wherein said props are adapted to be received between a first base member which supports the dial face and gnomon, and a second base member which is adapted to be placed on said surface.

26. A sundial comprising a substantially horizontal dial face provided with dial markings, a gnomon supported in a fixed position relative to the dial face, and a locating member which in use provides at least two abutment points defining an orientation reference line, said locating member being adapted to allow the orientation of the reference line relative to the dial face and gnomon to be set to at least one of a range of alternative orientations.

27. A sundial according to claim 26, further comprising the features of any one of claims 2 to 16.

28. A sundial according to claim 27 and having the features of claim 14, wherein the dial face is provided by said base and said gnomon is supported on the face.

29. A kit of parts comprising a sundial face, gnomon, and base for assembly into a sundial according to any preceding claim.

30. A sundial, substantially as hereinbefore described, with reference to the accompanying drawings.
